(19) United States
(12) Patent Application Publication
(10) Pub. No.: US 2010/0242685 A1
(43) Pub. Date: Sep. 30, 2010

(54) Ratchet wrench capable of preventing disengagement of nut

(76) Inventor: Chih-Min Chang, Changhua Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/385,105

(22) Filed: Mar. 31, 2009

(51) Int. Cl. B25B 13/46

(52) U.S. Cl. 81/63.2

(57) ABSTRACT

A ratchet wrench includes a wrench body having a through hole, a driving member rotatably mounted in the through hole and having a center hole for engagement with a nut, and a block ring capped on the driving member and having a stop flange to retain the nut in the center hole such that the nut is unable to drop out of the center hole of the driving member when the nut is tightened or loosened by the ratchet wrench.

### BACKGROUND OF THE INVENTION

1. Field of the Invention

The present invention relates to a ratchet wrench and more particularly, to a ratchet wrench that can prevent accidental disengagement of a nut held therein during operation.

2. Description of the Related Art

A conventional ratchet wrench includes a coupling hole at a distal end thereof and a driving member rotatably mounted in the through hole for engagement with a nut such that the nut can be tightened or loosened through the rotation of the driving member.

According to the aforesaid design, the coupling hole is a through hole defined through top and bottom sides of the distal end of the ratchet wrench such that the nut may easily drop out of the through hole, causing the nut to be difficultly screwed onto a bolt. Under this circumstance, a worker must put the nut into the through hole again, and may adjust the position between the nut and the bolt until the nut is threaded with the bolt. Further, the ratchet wrench is likely to slip from the worker's hand during tightening or loosening the nut due to the separation of the nut from the through hole, possibly causing damage to the worker. Therefore, it is desirable to provide a ratchet wrench that can eliminate the aforesaid drawbacks.

### SUMMARY OF THE INVENTION

The present invention has been accomplished under the circumstances in view. It is the main objective of the present invention to provide a ratchet wrench, which can prevent disengagement of a nut from a coupling portion thereof.

To achieve this objective of the present invention, the ratchet wrench comprises a wrench body, a driving member, a pawl, a positioning device and a block ring. The wrench body has a head, a through hole through top and bottom sides of the head, and a chamber recessed inwards at a periphery of the through hole. The driving member is rotatably mounted in the through hole of the wrench body, and has a center hole and an annular teeth portion around an outer periphery thereof. The pawl is mounted in the chamber of the wrench body and has a toothed front wall engaged with the annular teeth portion of the driving member. The positioning device is mounted in the chamber of the wrench body and abutted against the pawl for supporting the pawl against the driving member. The block ring is capped on the driving member and has a stop flange extending inwards along a radial direction thereof so as to define an opening that is smaller in area than the center hole of the driving member.

Accordingly, when the ratchet wrench of the prevent invention is engaged with a nut through the center hole of the driving member, the nut can be retained in the center hole of the driving member by the stop flange of the block ring without disengaging from the center hole, thereby enhancing the convenience of securing the nut.

### BRIEF DESCRIPTION OF THE DRAWINGS

FIG. 1 is a perspective view of a ratchet wrench according to a preferred embodiment of the present invention.

FIG. 2 is an exploded view of the ratchet wrench according to the preferred embodiment of the present invention.

FIG. 3 is a cross-sectional view taken along line 3-3 of FIG. 1.

FIG. 4 is similar to FIG. 3, showing a nut is engaged with the center hole of the driving member.

FIG. 5 is a partial cutaway view of the ratchet wrench according to the preferred embodiment of the present invention, showing the pawl is stopped against the driving member for allowing clockwise rotation of the driving member.

FIG. 6 is similar to FIG. 5, but showing the pawl is stopped against the driving member at another position for allowing counterclockwise rotation of the driving member.

### DETAILED DESCRIPTION OF THE INVENTION

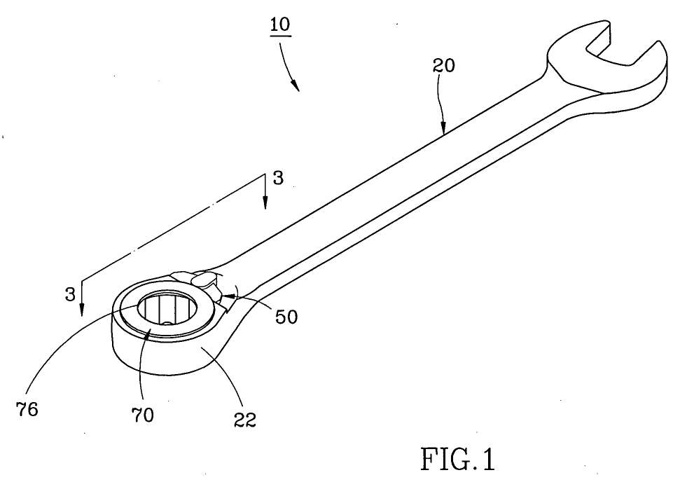

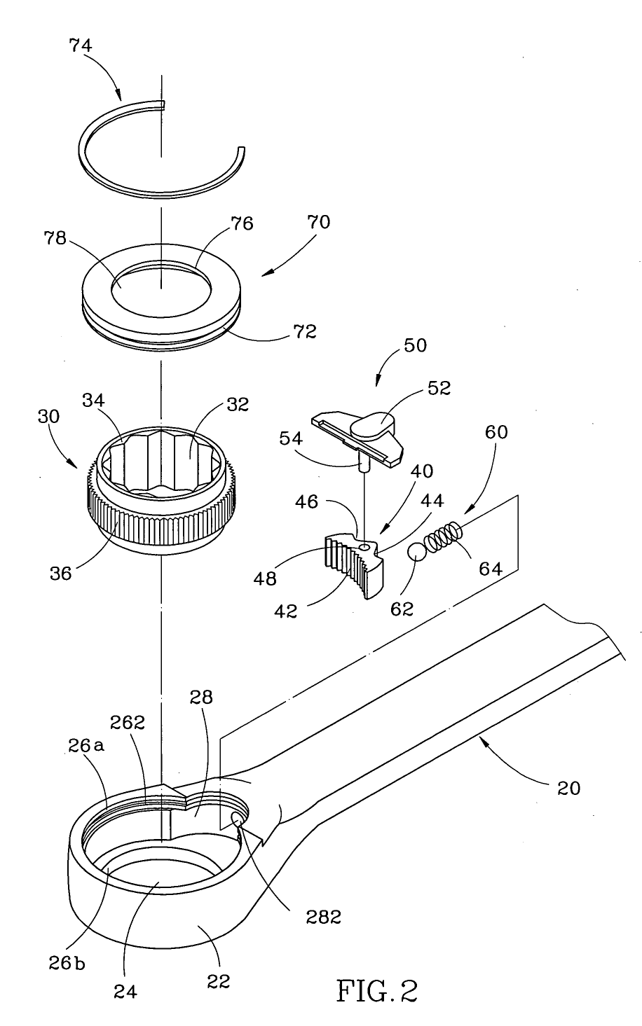

Referring to FIGS. 1 and 2, a ratchet wrench 10 in accordance with the preferred embodiment of the present invention is shown, comprising a wrench body 20, a driving member 30, a pawl 40, a slider 50, a positioning device 60, a block ring 70.

The wrench body 20 has a head 22, a through hole 24 through top and bottom sides of the head 22, two flanges 26a, 26b projecting inwards from peripheries of top and bottom ends of the through hole 24, a chamber 28 recessed inwards at the periphery of the through hole 28, and a blind hole 282 recessed inwards at a periphery of the chamber 28. The flange 26a has a first insertion groove 262.

The driving member 30 is rotatably mounted in the through hole 24 of the wrench body 20, and has a center hole 32 coaxial to the through hole 32 for engagement with a nut, an inner annular teeth portion 34 around an inner periphery thereof, and an outer annular teeth portion 36 around an outer periphery thereof.

The pawl 40 is mounted in the chamber 28 and provided with a toothed front wall 42 facing the driving member 30 so that the toothed front wall 42 can be forced into engagement with the outer annular teeth portion 36 of the driving member 30. The pawl 40 further includes a left concavity 44 at the rear side thereof, a right concavity 46 at the rear side thereof, and a coupling hole 48 through the top and bottom sides.

The slider 50 has a tab 52 and a coupling portion 54 extending from the bottom side of the tab 52 and inserted into the coupling hole 48 of the pawl 40 such that the slider 50 can be forced to move the pawl 40 in the chamber 28.

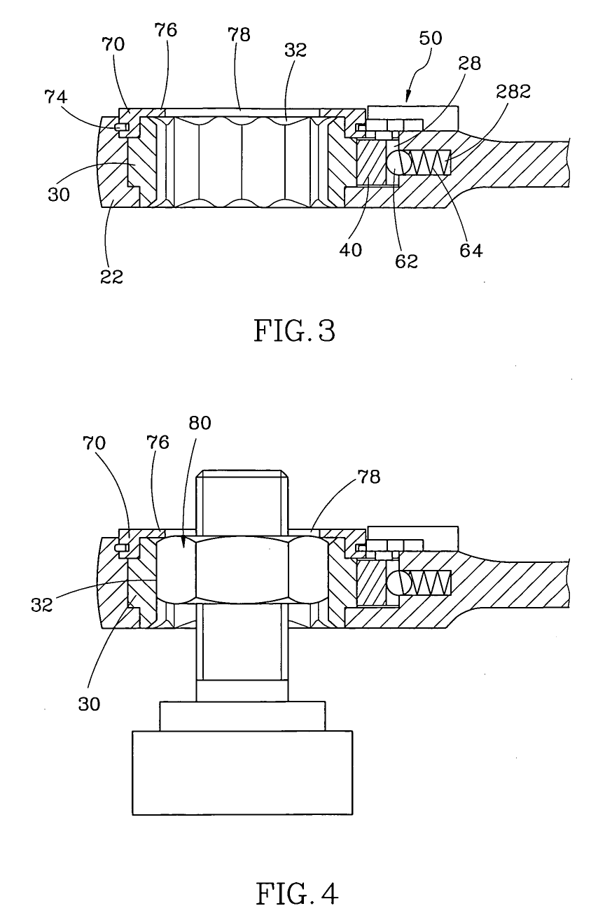

As shown in FIG. 3, the positioning device 60 is mounted in the blind hole 282 of the wrench body 20, having a ball 62 and a spring member 64 with two ends stopped against the ball 62 and a bottom wall of the blind hole 282 for providing a spring force to push the ball 62 into engagement with either of the left recess 44 and the right recess 46 of the pawl 40, enabling the toothed front wall 42 of the pawl 40 to be engaged with the outer annular teeth portion 36 of the driving member 30.

The block ring 70 is axially capped on the driving member 30, having a second insertion groove 72 at an outer periphery thereof corresponding to the first insertion groove 262 of the wrench body 20, and a stop flange 76 extending inwards along a radial direction thereof to define an opening 78 that is smaller in area than the center hole 32 of the driving member 30. A retainer 74 is fastened to the second insertion groove 72 of the block ring 70 and engaged with the first insertion groove 262 of the wrench body 20 to secure the block ring 70 to the wrench body 20.

As shown in FIG. 4, when the ratchet wrench 10 of the present invention is engaged with a nut 80 through the center hole 32 of the driving member 30, the nut 80 can't pass through the opening 78 due to the obstruction of the stop flange 76 of the block ring 70 so as to be retained in the center hole 32 of the driving member 30. As a result, when a worker uses the ratchet wrench 10 of the present invention to tighten or loosen the nut 80, the nut 80 is unable to drop out of the center hole 32 of the driving member 30, and the ratchet wrench 10 is unable to slip from the worker's hand, thereby enhancing the convenience of tightening and loosening the nut 80, and reducing the risk of occupational injuries.

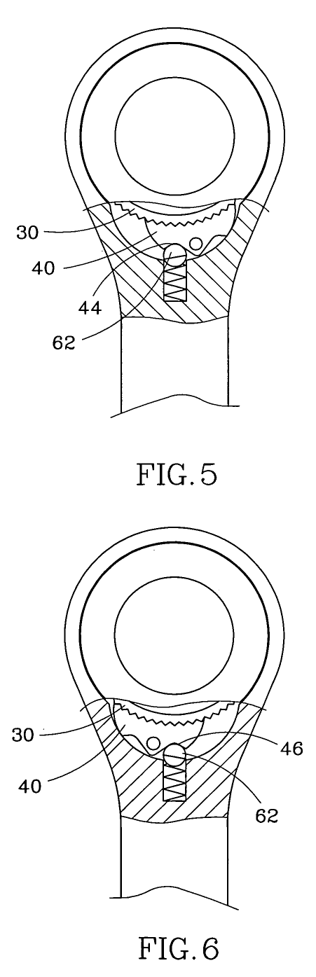

Furthermore, the worker can force the slider 50 to move the pawl 40 in the chamber 28 for controlling the rotational direction of the driving member 30. When the worker moves the slider 50 rightwards, the ball 62 of the positioning device 60 is stopped against the left recess 44 of the pawl 40, allowing clockwise rotation of the driving member 30 in the head 22 of the wrench body 20, as shown in FIG. 5. On the contrary, when the worker moves the slider 50 leftwards, the ball 62 of the positioning device 60 is stopped against the right recess 44 of the pawl 40, allowing counterclockwise rotation of the driving member 30 in the head 22 of the wrench body 20, as shown in FIG. 6.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A ratchet wrench comprising:
a wrench body having a head, a through hole through top and bottom sides of the head, and a chamber recessed inwards at a periphery of the through hole;
a driving member rotatably mounted in the through hole of the wrench body, and having a center hole and an annular teeth portion around an outer periphery thereof;
a pawl mounted in the chamber of the wrench body and having a toothed front wall engaged with the annular teeth portion of the driving member;
a positioning device mounted in the chamber of the wrench body and abutted against the pawl for supporting the pawl against the driving member; and
a block ring axially capped on the driving member and having a stop flange extending inwards along a radial direction thereof to define an opening that is smaller in area than the center hole of the driving member,.
wherein the block ring is a closed ring.

2. The ratchet wrench as claimed in claim 1, further comprising a slider connected to the pawl to move the pawl in the chamber.

3. The ratchet wrench as claimed in claim 2, wherein the pawl has a coupling hole, and the slider has a coupling portion inserted into the coupling hole of the pawl.

4. The ratchet wrench as claimed in claim 1, wherein the positioning device includes a ball stopped against the pawl, and a spring member received in a blind hole recessed inwards at a periphery of the chamber of the wrench body and having two ends stopped against the ball and a bottom wall of the blind hole.
